(19) United States
(12) Patent Application Publication
(10) Pub. No.: US 2026/0343452 A1
(43) Pub. Date: Oct. 29, 2026

(54) MULTI-TRANSMISSION RECEPTION POINT OPERATIONS ASSOCIATED WITH MULTIPLE TIMING ADVANCE GROUPS

(71) Applicant: QUALCOMM Incorporated, San Diego, CA (US)

(72) Inventors: Jing LEI, San Diego, CA (US); Mostafa KHOSHNEVISAN, San Diego, CA (US); Ruiming ZHENG, Beijing (CN)

(21) Appl. No.: 19/123,363

(22) PCT Filed: Nov. 24, 2022
(86) PCT No.: PCT/CN2022/133883

§ 371 Date: Apr. 22, 2025

(51) Int. Cl. H04W 56/00

(52) U.S. Cl. CPC H04W 56/0045

(57) ABSTRACT

A UE receives an inquiry for a multi-transmission reception point (mTRP) operation with multiple timing advance groups (mTAGs) capability of the UE. The UE also reports the mTRP operation with the mTAGs capability of the UE in response to the inquiry. The UE further receives a configuration based on the mTRP operation with the mTAGs capability.

### TECHNICAL FIELD

The present disclosure relates generally to communication systems, and more particularly, to wireless communications utilizing multiple transmission reception points.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may include memory and at least one processor coupled to the memory. Based at least in part on information stored in the memory, the at least one processor is configured to receive an inquiry for a multi-transmission reception point (mTRP) operation with multiple timing advance groups (mTAGs) capability of the UE, report the mTRP operation with the mTAGs capability of the UE in response to the inquiry, and receive a configuration based on the mTRP operation with the mTAGs capability.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of abase station and user equipment (UE) in an access network.

FIG. 4 is a diagram illustrating a serving cell including a first physical layer and a second physical layer.

FIG. 5 is a diagram illustrating a single downlink control information transmission mode.

FIG. 6 is a diagram illustrating a multi-downlink control information transmission mode.

FIG. 7 is a call flow diagram illustrating a method of wireless communication between a network node and a user equipment in accordance with various aspects of this present disclosure.

FIG. 8 is a diagram illustrating uplink transmissions from a user equipment to multiple transmission reception points utilizing a single transmit antenna in accordance with various aspects of the present disclosure.

FIG. 9 is a diagram illustrating synchronous uplink transmissions from a user equipment to multiple transmission reception points utilizing a single transmit antenna in accordance with various aspects of the present disclosure.

FIG. 10 is a diagram illustrating asynchronous uplink transmissions to multiple transmission reception points associated with different timing advance groups on different bandwidth parts and component carriers utilizing a single transmit antenna in accordance with various aspects of the present disclosure.

FIG. 11 is a flowchart illustrating methods of wireless communication at a user equipment in accordance with various aspects of the present disclosure.

FIG. 12 is a flowchart illustrating methods of wireless communication at a network node in accordance with various aspects of the present disclosure.

FIG. 13 is a diagram illustrating an example of a hardware implementation for an example apparatus and/or network entity.

FIG. 14 is a diagram illustrating an example of a hardware implementation for an example network entity.

### DETAILED DESCRIPTION

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NRBS, 5G NB, access point (AP), a transmission reception point (TRP), or a cell, etc.) may be implemented as an aggregated base station (also known as a standalone BS or a monolithic BS) or a disaggregated base station.

A n aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

Various aspects relate generally to wireless communication and more particularly to multi-transmission reception point (mTRP) operations with mTAGs. Some aspects more specifically relate to enabling a reduced capability (RedCap) or reduced complexity (RedComp) user equipment (UE) (e.g., a UE utilizing a single transmit antenna) to transmit signals to different TRPs with mTAGs at different time instances utilizing transmit beam switching, bandwidth switching and/or carrier frequency switching. In some aspects, the network may configure the UE such that that uplink signal transmission to different TRPs with mTAGs takes into account the absolute minimum transmit timing supported by the multiple TRPs and the time it takes for the UE to switch transmit beams to different TRPs. In one example, the signals may be transmitted by the UE via the same uplink bandwidth part (BWP) and the same frame index, slot index, and symbol index. As such, the network may perceive the signals to be transmitted synchronously with respect to the DL timing difference associated with each TAG, even though the UE transmits the signals towards each TRP at different time instances. In another example, the UE may transmit signals asynchronously to different TRPs with mTAGs via different BWPs and carrier frequencies. In this example, the network may configure the UE such that uplink signal transmission to different TRPs with mTAGs takes into account the absolute minimum transmit timing supported by the multiple TRPs and the time it takes for the UE to switch transmit beams to a different TRP, switch BWPs, and switch carrier frequencies.

Particular aspects of the subject matter described in this disclosure can be implemented to realize one or more of the following potential advantages. In some examples, by configuring a RedCap UE or RedComp UE to take into account the absolute minimum transmit timing supported by multiple TRPs as well as the time it takes the UE to switch beams, BWPs, and/or carrier frequencies, the described techniques enable a RedCap UE or RedComp UE to transmit signals to different TRPs with mTAGs utilizing a single transmit antenna. Supporting mTRP operations with mTAGs for a RedCap UE or a RedComp UE may be advantageous to both the UE and the network. For instance, such aspects may achieve load balancing for uplink traffic across multiple TRPs, time and space diversity for uplink data and control, and improved coverage, reliability, and/or capacity.

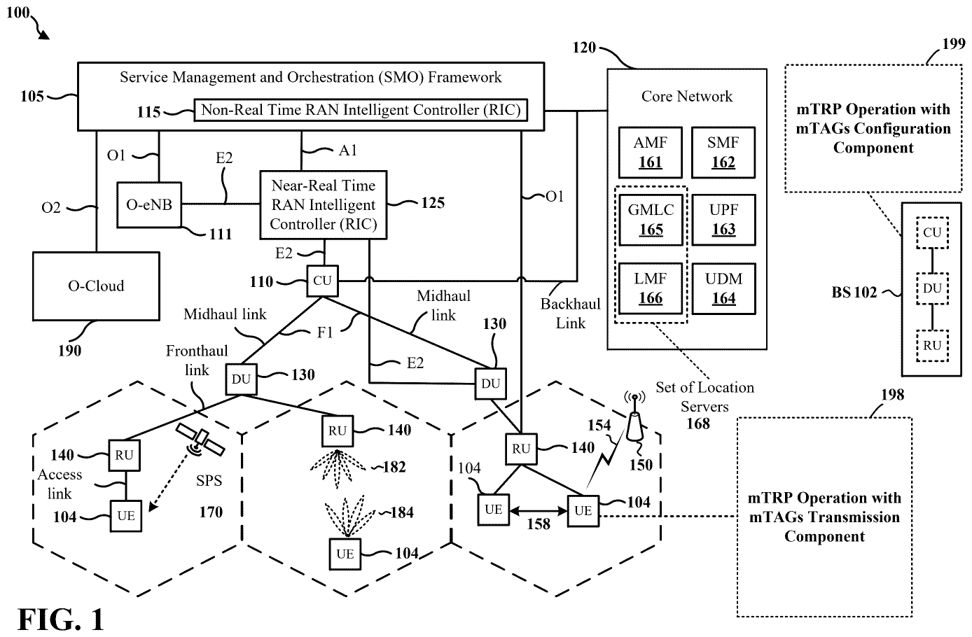

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be synchronously served by multiple RUs 140.

E ach of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit—User Plane (CU-UP)), control plane functionality (i.e., Central Unit—Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, amidium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/M L) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as AI policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base stations 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base stations 102/UEs 104 may use spectrum up to YMHz (e.g., 5, 10, 15, 20, 100, 400, etc. MHz) bandwidth per carrier allocated in a carrier aggregation of up to a total of Y×M Hz (x component carriers) used for transmission in each direction. The carriers may or may not be adjacent to each other. Allocation of carriers may be asymmetric with respect to DL and UL (e.g., more or fewer carriers may be allocated for D L than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EH F) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EH F band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NRE-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may have a component 198 that may be configured to receive an inquiry for an mTRP operation with mTAGs capability of the UE, report the mTRP operation with the mTAGs capability of the UE in response to the inquiry, and receive a configuration based on the mTRP operation with the mTAGs capability. In certain aspects, the base station 102 may have a component 199 that may be configured to provide an inquiry for an mTRP operation with mTAGs capability of a UE, receive information indicating the mTRP operation with the mTAGs capability of the UE, and provide a configuration based on the mTRP operation with the mTAGs capability.

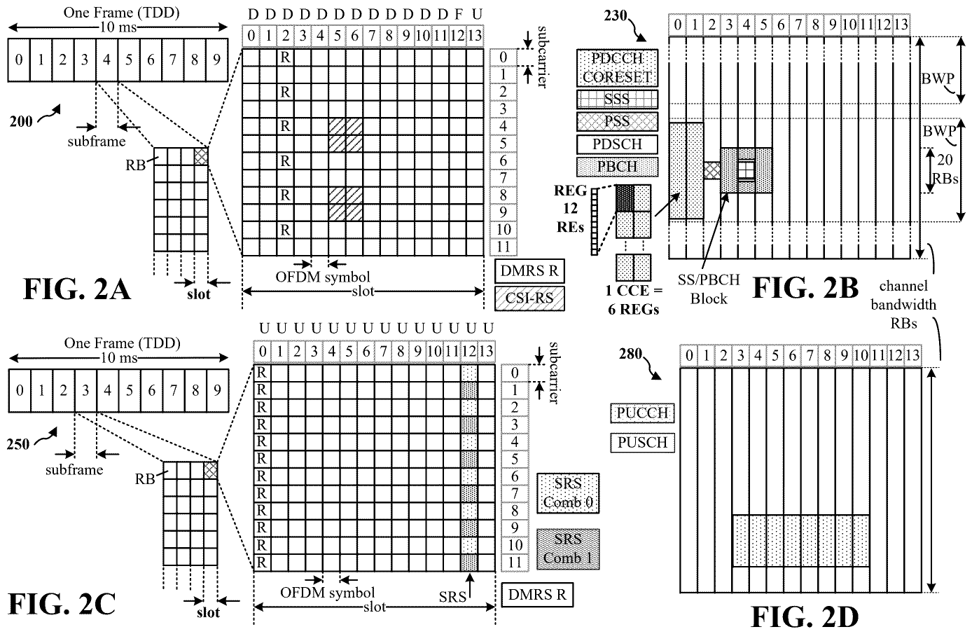

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description irfra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various D L channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CO RESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

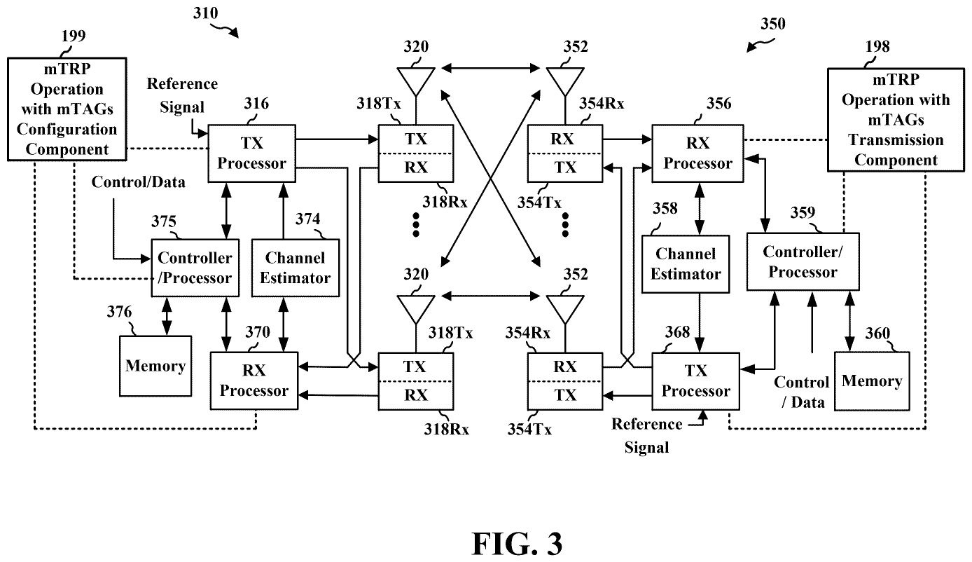

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the mTRP operation with mTAGs transmission component 198 of FIG. 1.

At least one of the TX processor 316, the RX processor 370, and the controller/processor 375 may be configured to perform aspects in connection with the mTRP operation with mTAGs configuration component 199 of FIG. 1.

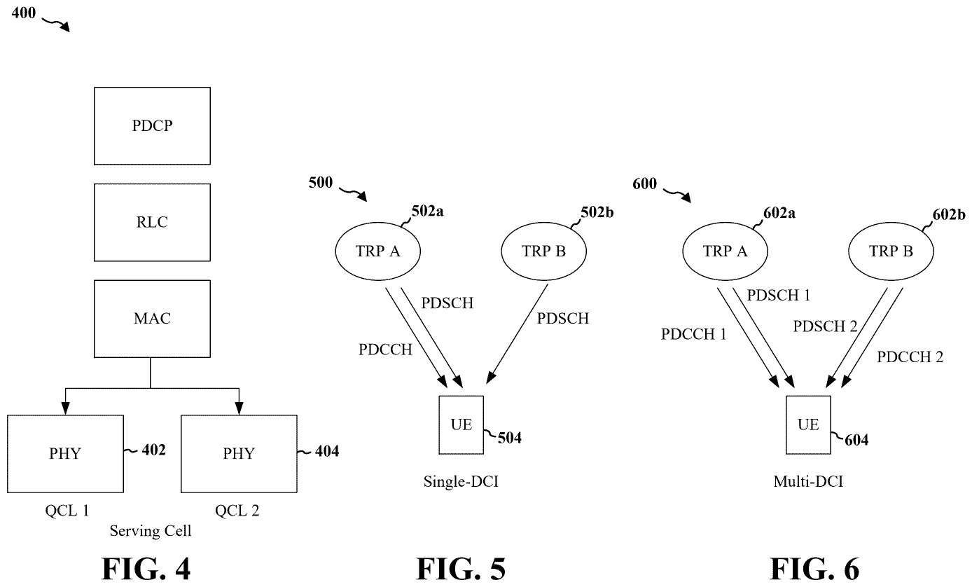

FIG. 4 is a diagram 400 illustrating a serving cell including an example layer structure for a serving cell having two TRPs. The example layer structure includes separate PHY layers for the two TRPs, e.g., a first PHY layer 402 and a second PHY layer 404. The first PHY layer 402 may be associated with a first TRP of the serving cell, and the second PHY layer 404 may be associated with a second TRP of the serving cell. The first and second TRPs may have the same physical cell idea (PCI), as they are both associated with the same serving cell. The first PHY layer 402 may be associated with a first quasi-co-location (QCL1), and the second PHY layer 404 may be associated with a second QCL (QCL2). The separate PHY layers may share a joint MAC layer, RLC layer, and PDCP.

There may be two different operation modes for mTRP communication. One mode is a single DCI (sDCI) transmission mode in which a UE receives a single DCI that schedules communication for multiple TRPs. For example, FIG. 5 is a diagram 500 illustrating an sDCI transmission mode. As shown in FIG. 5, a first TRP 502a establishes a PDCCH with a UE 504. The PDCCH provides a single DCI, which schedules a PDSCH between the first TRP 502a and the UE 504, as well as a PDSCH between a second TRP 502b and the UE 504. Accordingly, in the sDCI transmission mode, the UE 504 receives a single DCI in order to receive multiple PDSCHs. The sDCI transmission mode may be applicable when the first TRP 502a and the second TRP 502b are coupled via an ideal backhaul, where the timing for the PDSCH of the first TRP 502a is the same or similar as the timing for the PDSCH of the second TRP 502b due to the distance between the first TRP 502a and the second TRP 502b being relatively short.

Another mode is a multi-DCI (mDCI) transmission mode in which for data communication with each of multiple TRPs, a UE receives control information from the respective TRP. For example, FIG. 6 is a diagram 600 illustrating a multi-DCI (mDCI) transmission mode. As shown in FIG. 6, a first TRP 602a establishes a first PDCCH (PDCCH 1) with a UE 604, and a second TRP 602b establishes a second PDCCH (PDCCH 2) with the UE 604. The first PDCCH provides a first DCI, which schedules a PDSCH (PDSCH 1) between the first TRP 602a and the UE 604. The second PDCCH provides a second DCI, which schedules a PDSCH (PDSCH 2) between the second TRP 602b and the UE 604. Accordingly, in the mDCI transmission mode, the UE 604 receives multiple DCI in order to receive multiple PDSCHs. The mDCI transmission mode may be applicable when the first TRP 602a and the second TRP 602b are coupled via an ideal backhaul. The mDCI transmission mode may also be applicable when the first TRP 602a and the second TRP 602b are coupled via a non-ideal backhaul, where the timing for the PDSCH of the first TRP 602a is different than the timing for the PDSCH of the second TRP 602b due to distance between first TRP 602a and the second TRP 602b being relatively long.

The mDCI transmission mode also supports PDCCH repetition, where each PDCCH includes the same DCI payload. The mDCI transmission mode may also utilize single-frequency network (SFN) transmission. For example, when the first TRP 602a transmits a packet, the second TRP 602b may repeat that packet. The packets may be transmitted at the same time or with a timing offset. From the perspective of the UE 604, the UE 604 may assume that the packets are transmitted from the same network node. That is, different TRPs from the same network may transmit the same packet, and therefore, function as an SFN.

It is noted that mTRP also supports uplink transmissions (e.g., via PUSCH and PUCCH). When a UE transmits uplink transmissions to two different TRPs, the UE may utilize time division multiplexing (TDM), where an uplink transmission to a first TRP and an uplink transmission to a second TRP are transmitted at different times. By using TDM, the UE may use full power when transmitting each uplink transmission to a respective TRP. As such, the coverage and reliability for the uplink transmissions are not compromised.

The mTRP communication may be based on the sDCI mode with spatial division multiplexing (SDM) or SFN based communication for synchronous transmission to a UE from the mTRPs, e.g., rather than TDM based communication. The mTRP communication may be based on the mDCI mode with SDM or a frequency division multiplexing (FDM) based communication for synchronous transmission to a UE from the mTRPs, e.g., rather than TDM based communication.

A UE may communicate with one or more TRPs using one beamformed direction. In response to different conditions, the UE may switch to communication using a different beam. In some examples, abase station may send a transmission that triggers a beam switch by the UE. For example, the base station may indicate a transmission configuration indication (TCI) state change, and in response, the UE may switch to a new beam based on the new TCI state. A TCI state may include quasi co-location (QCL) information that the UE can use to derive timing/frequency error and/or transmission/reception spatial filtering for transmitting/receiving a signal. Two antenna ports may be said to be quasi co-located if properties of the channel over which a symbol on one antenna port is conveyed can be inferred from the channel over which a symbol on the other antenna port is conveyed. The base station may indicate a TCI state to the UE as a transmission configuration that indicates QCL relationships between one signal (e.g., a reference signal) and the signal to be transmitted/received. For example, a TCI state may indicate a QCL relationship between DL RSs in one RS set and PDSCH/PDCCH DM-RS ports. TCI states can provide information about different beam selections for the UE to use for transmitting/receiving various signals. Under a unified TCI framework, different types of common TCI states may be indicated. For example, a type 1 TCI may be a joint DL/UL common TCI state to indicate a common beam for at least one DL channel or RS and at least one UL channel or RS. A type 2 TCI may be a separate DL (e.g., separate from UL) common TCI state to indicate a common beam for more than one DL channel or RS. A type 3 TCI may be a separate UL common TCI state to indicate a common beam for more than one UL channel/RS. A type 4 TCI may be a separate DL single channel or RS TCI state to indicate a beam fora single DL channel or RS. A type 5 TC may be a separate UL single channel or RS TCI state to indicate a beam for a single UL channel or RS. A type 6 TC may include UL spatial relation information (e.g., such as sounding reference signal (SRS) resource indicator (SRI)) to indicate a beam for a single UL channel or RS. In some aspects, a unified TCI framework may be extended for intra-cell and/or inter-cell mTRP communication.

Communication with mTRPs may be supported by low-tier device types with reduced capability (RedCap) or non-RedCap device types with regular or higher capability, but that operate with reduced complexity (RedComp) (e.g., in a power saving mode). Examples of regular or higher capability devices include premium smartphones, V2X devices, URLLC devices, eMBB devices, etc. Examples of reduced capability devices may include wearables, industrial wireless sensor networks (IWSN), surveillance cameras, low-end smartphones, etc. For example, NR communication systems may support both higher capability devices and reduced capability devices. A reduced capability device may be referred to as an NR light device, a low-tier device, a lower tier device, etc. Reduced capability UEs may communicate based on various types of wireless communication. For example, smart wearables may transmit or receive communication based on low power wide area (LPWA)/mMTC, relaxed IoT devices may transmit or receive communication based on URLLC, sensors/cameras may transmit or receive communication based on eMBB, etc.

In some examples, a reduced capability UE may have an uplink transmission power of at least 10 dB less than that a higher capability UE. As another example, a reduced capability UE may have reduced transmission bandwidth or reception bandwidth than other UEs. For instance, a reduced capability UE may have an operating bandwidth between 5 MHz and 10 MHz for both transmission and reception, in contrast to other UEs which may have 20-100 MHz bandwidth. As a further example, a reduced capability UE may have a reduced number of reception antennas in comparison to other UEs. For instance, a reduced capability UE may have only a single receive antenna and may experience a lower equivalent receive signal to noise ratio (SNR) in comparison to higher capability UEs that may have multiple antennas. Reduced capability UEs may also have reduced computational complexity than other UEs.

A RedComp UE may refer to a UE that is configured with a reduced complexity, and may also refer to a UE that is operating in a reduced complexity mode. For example, the UE may support higher complexity communication and reduced complexity communication, and may be referred to as a RedComp UE when supporting or operating with reduced complexity.

A RedCap UE or a RedComp UE may support a reduced number of antenna branches relative to a higher capability or higher complexity UE. As an example, a RedCap UE may support up to 2 Rx antenna branches and up to 2 Tx antenna branches or may support a lower number of Rx/Tx antenna branches, a lower-order modulation, lower transmit power, and may operate in both FR1 and FR2. A RedCap UE may optionally support certain mTRP UE features, including, but not limited to, mTRP operation with two timing advance groups (TAGs) on the same component carrier (CC). Each TRP (e.g., the TRPs 502a, 502b, 602a, 602b) may be associated with a particular TAG, where each TRP may be configured to receive a plurality of signals in parallel across different CCs.

In accordance with the aspects of the present disclosure, mTRP operation may be enhanced with multiple TA groups. For example, mTRP operation may be extended to UEs operating with a reduced number of Tx antenna branches/panels to achieve power saving, smaller form factors, or lower cost. In accordance with such aspects, even if a single Tx antenna branch/panel with multiple antenna elements is activated for a UE, the UE can still steer its Tx beam to different TRPs at different time instances. Such aspects may be utilized for various use cases, including, but not limited to reconfigurable intelligent surface (RIS)-assisted communication, asset tracking, IoT devices (e.g., on vehicles), mTRPs mounted on unmanned aerial vehicles (e.g., drones) and rooftops, etc.

Supporting mTRP operations by UE-based Tx beam switching may be beneficial for both the UE and the network. For example, such aspects may provide load balancing for uplink traffic across multiple TRPs, time and space diversity for uplink data and control, and enhancement of coverage, reliability and capacity. It is noted that aspects of the present disclosure may be utilized for both RedCap UEs and reduced complexity (RedComp UEs). A RedComp UE may be an advanced UE (e.g., a UE with more than 2 Tx and Rx antennas) that operates in a reduced capability mode, where 1 Tx and 1 Rx antenna branch/panel is activated and other Tx and Rx antenna branches/panels are deactivated (e.g., as a power savings measure). In accordance with aspects of the present disclosure, a RedCap UE and a RedComp UE may support mTRP operations with different TAGs associated with the same BWP (e.g., intra-BWP) or different BWPs (e.g., inter-BWP) and different TAGs associated the same cell (intra-cell) or different cells (e.g., inter-cells).

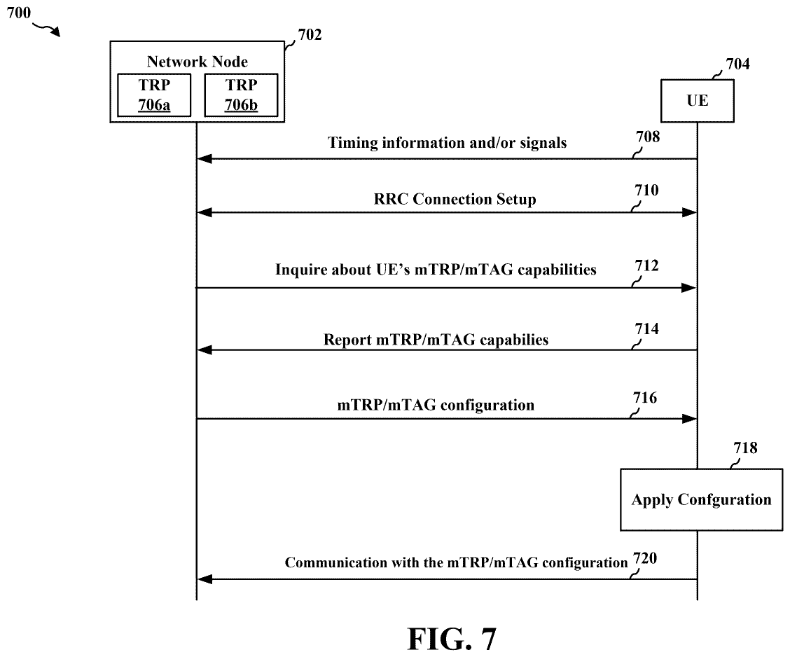

In accordance with aspects of the present disclosure, the network may provide a UE capable of mTRP operations with mTAGs with one or more configurations that enable the UE to perform mTRP operations with mTAG. A DL reference timing for each TAG may be separately configured. A PDCCH ordered RACH may be supported for an mDCI mode. A TAG may be associated with one or more of a TCI state or spatial relation, a CORESET pool index, or an SB group. A TAG ID may be configured, e.g., RRC configured, for periodic or semi-persistent scheduling (SPS), and may be activated by DCI or other control signaling. For example, FIG. 7 is a call flow diagram 700 illustrating a method of wireless communication between a network node 702 and a UE 704 in accordance with various aspects of this present disclosure. Although aspects are described for a network node, the aspects may be performed by a network node in aggregation and/or by one or more components of the network node 702 (e.g., such as a CU 110, a DU 130, and/or an RU 140). The network node 702 may be further communicatively coupled to a plurality of TRPs (e.g., TRPs 706a and 706b). Each of the TRPs 706a and 706b may be associated with a respective TAG. Each of the TRPs 706a and 706b may support the same CC or different CCs (where the different CCs may belong to the same cell group, or different cell groups). As shown in FIG. 7, at 708, the network node 702 may broadcast timing-related information and/or signals for one or more UEs (e.g., UE 704) supported by a scheduler (e.g., of the network node 702) for mTRP operations with multiple TAGs on the same CC or different CC. The timing-related information and/or signals may inform the UE(s) of the TRP setup (e.g., the number of TRPs and relative distances of the TRPs from the UE(s)) utilized by the network node 702). The timing-related information and/or signals may include transmit timing differences for an mTRP operation, downlink timing difference value associated with different mTAGs and/or a respective downlink timing reference signal for each TAG of the mTAGs.

At 710, an RRC connection is setup between the UE 704 and each of the TRP 706a and 706b based on the timing information and/or signals. The RRC connection setup may configure the UE 704 with one or more parameters associated with transmitting an uplink transmission.

At 712, the network node 702 may inquire about the mTRP operation with mTAG capabilities of the UE(s) (e.g., the UE 704). For example, the network node 702 may provide a request to the UE 704 for its mTRP operation with mTAG capabilities (e.g., assuming that the network node 702 supports mTRP operation with mTAG operations of a UE with a reduced number of Tx antenna branches).

In an aspect, the UE 704 is a RedCap UE or RedComp UE that supports a number of transmission antenna branches that is less than the number of TRPs associated with the network node 702. Accordingly, the mTRP operation with the mTAGs capability is for a RedCap UE or RedComp UE.

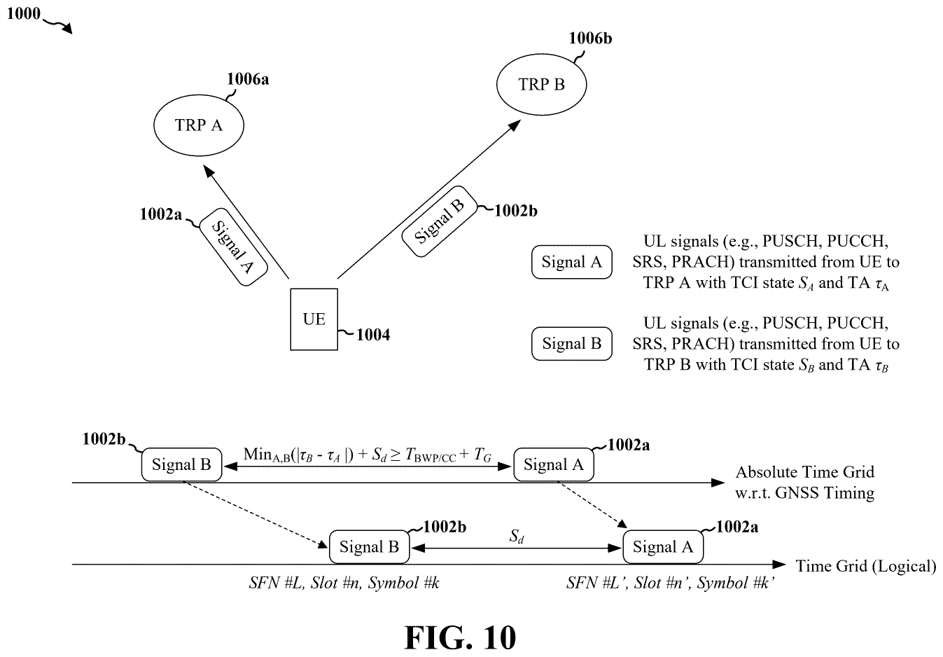

At 714, the UE 704 may report the number of Tx and/or Rx antennas that are activated and/or its one or more mTRP operation with mTAG capabilities to the network node 702. In one aspect, an mTRP operation with mTAG capability is associated with a minimum transmit switching gap (T_{G}) supported by the UE 704. The minimum transmit switching gap may indicate a minimum amount of time for the UE 704 to perform Tx beam switching (i.e., to switch a Tx beam towards a particular TRP) and/or RF retuning. In an aspect, the UE 704 may also report a bandwidth part (BWP) switching capability and/or a component carrier (CC) (or carrier frequency) switching capability. The BWP switching capability may specify a minimum amount of time that the UE 704 takes to switch BWPs. The carrier frequency switching capability may specify a minimum amount of time that the UE 704 takes to switch carrier frequencies. As will be described below with reference to FIG. 10, the UE 704 may report such capabilities to enable asynchronous uplink transmissions to multiple TRPs associated with different TAGs on different BWPs/CCs.

At 716, the network node 702 may provide an mTRP operation with mTAG configuration to the UE 704 that is based on the capabilities reported by the UE 704 and restrictions of the network node 702. For example, based on the capabilities reported by the UE 704, the network node 702 may configure for the UE 704 a first (e.g., a source) uplink BWP on the TRP 706a and a second (e.g., a target) uplink BWP on the TRP 706b, where the source uplink BWP and the target uplink BWP are associated with different TAGs and the absolute minimum transmit timing difference (minTTD) supported by the TRPs 706a and 706b is no less than the minimum transmit switching gap (T_{G}). In an aspect, the source uplink BWP may be associated with a first TAG (e.g., TRP 706a) and the second uplink BWP may be associated with a second TAG (e.g., TRP 706b). In an aspect, the absolute minimum transmit timing difference supported by the first TRP and the second TRP is no less than the minimum transmit switching gap (T_{G}).

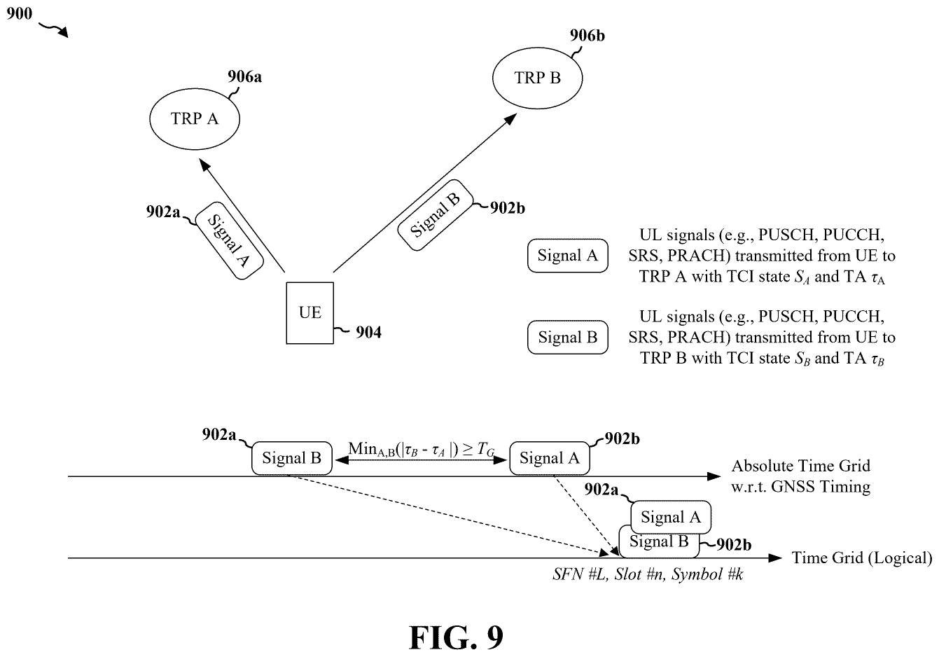

As will be described below with reference to FIG. 9, in an aspect, the mTRP operation with mTAG configuration may enable synchronous uplink transmissions (from a logical time standpoint) to multiple TRPs associated with different TAGs. In such an aspect, the configuration configures the UE 704 to transmit an uplink signal to a first TRP (e.g., the TRP 706a) and an uplink signal to a second TRP (e.g., the TRP 706b) via the same uplink bandwidth part and at least one of a same frame index, slot index, or symbol index. In an aspect, the first uplink signal is associated with a first TAG and a first transmission configuration indicator (TCI) state and the second uplink signal is associated with a second TAG and a second TCI state.

As will be described below with reference to FIG. 10, in an aspect, the mTRP operation with mTAG configuration may enable synchronous uplink transmissions to multiple TRPs associated with different TAGs on different BWPs/CCs. In such an aspect, the configuration configures the UE 704 to transmit an uplink signal to a first TRP (e.g., the TRP 706a) via a first BWP and a first CC (or carrier frequency) and an uplink signal to a second TRP (e.g., the TRP 706b) via a second BWP and a second CC (or carrier frequency) that are different than the first BWP and the first CC, respectively. In an aspect, the configuration further configures the UE 704 with a time offset for accommodating an amount of time for the UE 704 to perform at least one of BWP switching or CC (or carrier frequency) switching.

In an aspect, the configuration may be provided to the UE 704 via DCI (e.g., sDCI mDCI), RRC signaling, or MAC control element (MAC-CE) signaling.

At 718, the UE 704 applies the configuration received at 716. At 720, the UE 704 communicates with the TRPs 706a and 706b based on the configuration applied at 718.

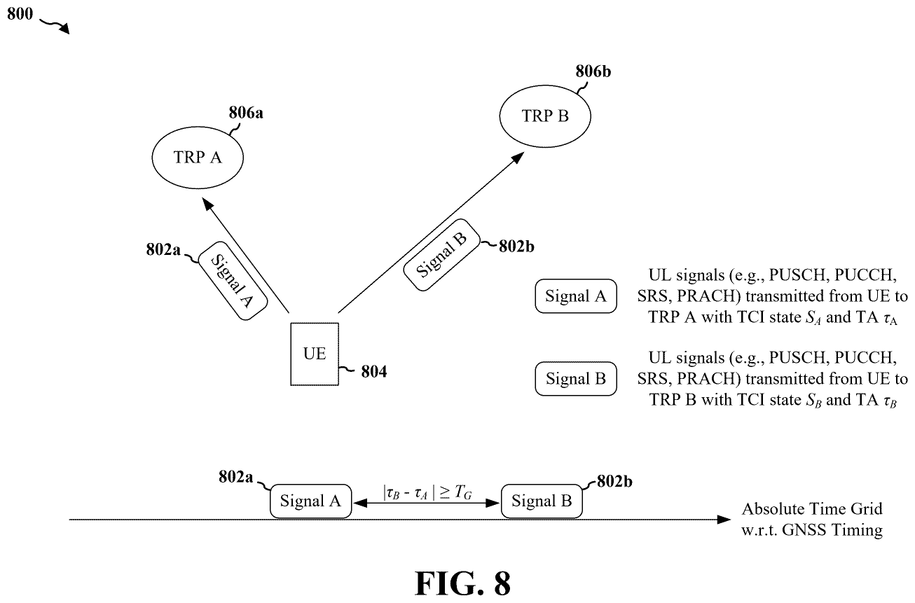

For example, FIG. 8 is a diagram 800 illustrating uplink transmissions from a UE to multiple TRPs utilizing a single Tx antenna in accordance with various aspects of the present disclosure. A UE with a single Tx antenna includes a single Tx chain or single Tx branch. The single Tx chain or single Tx branch includes a power amplifier, which is shared by one or multiple antenna elements, such that the UE cannot communicate with more than one TRP simultaneously. As shown in FIG. 8, a UE 804 is configured to transmit uplink signals utilizing a single Tx antenna in accordance with timing advance values received by a network node (e.g., via the configuration received at 716). In particular, the UE 804 may receive a first timing advance value (τ_{A}) associated with a first TRP 806a and a second timing advance value (τ_{B}) associated with a second TRP 806b. The UE 804 transmits a first signal 802a to the TRP 806a and a second signal 802b to the TRP 806b utilizing the same Tx antenna based on the timing advance values. The first signal 802a may be an uplink signal (e.g., a PUSCH, a PUCCH, an SRS, a PRACH, etc.) with a transmission configuration indicator (TCI) state (S_{A}) and a timing advance value (τ_{A}) associated with the first TRP 806a. The second signal 802b may bean uplink signal with a TCI state (S_{B}) and a timing advance value (τ_{B}) associated with the second TRP 806b. As shown via the absolute time grid (with respect to global navigation satellite system (GNSS)), the network (e.g., the network node 702) may ensure that the UL grant for the second signal 802b occurs before the UL grant for the first signal 802a (i.e., so that the second signal 802b is transmitted before the first signal 802a, as the distance between the UE 804 and the TRP 806b is greater than the distance between the UE 804 and the TRP 806a). The first signal 802a may be transmitted via a source uplink BWP, and the second signal 802b may be transmitted via a target uplink BWP (i.e., the first signal 802a and the second signal 802b may be transmitted via different BWPs). As also shown in FIG. 8, the time between transmitting first signal 802a and the second signal 802b is sufficient for the UE 804 to switch the Tx beam from the first TRP 806a to the second TRP 806b and perform RF tuning (i.e., |τ_{B}-τ_{A}|≥T_{G}).

In an aspect of the present disclosure, a UE may support synchronous uplink transmissions to multiple TRPs associated with different TAGs. For example, FIG. 9 is a diagram 900 illustrating synchronous uplink transmissions from a UE to multiple TRPs utilizing a single Tx antenna, where the transmission time of the UE towards each TRP is defined with respect to the DL timing difference associated with each TAG, respectively, in accordance with various aspects of the present disclosure. As shown in FIG. 9, a UE 904 is configured to transmit uplink signals utilizing a single Tx antenna in accordance with timing advance values received by a network node (e.g., via the configuration received at 716). In particular, the UE 904 may receive a first timing advance value (τ_{A}) associated with a first TRP 906a and a second timing advance value (τ_{B}) associated with a second TRP 906b. The UE 904 transmits a first signal 902a to the TRP 906a and a second signal 902b to the TRP 906b utilizing the same Tx antenna based on the timing advance values. The first signal 902a may bean uplink signal (e.g., a PUSCH, a PUCCH, an SRS, a PRACH, etc.) with a transmission configuration indicator (TCI) state (S_{A}) and a timing advance value (τ_{A}) associated with the first TRP 906a. The second signal 902b may bean uplink signal with a TCI state (S_{B}) and a timing advance value (τ_{B}) associated with the second TRP 906b.

The UE 904 may be scheduled by DCI or configured by RRC signaling or MAC-CE signaling to transmit the first signal 902a to the first TRP 906a and the second signal 902b to the second TRP 906b on the same uplink BWP and on the same system frame number (SFN) index, slot index, and/or symbol index of the corresponding time grid if the minimum transmit timing difference (minTTD) supported by the scheduler (or the minimum difference between Ta and reassociated with different TAGs) are no less than the minimum transmit switching gap (T_{G}). The DCI may be sDCI or mDCI. The first signal 902a and the second signal 902b may be associated with different TAGs and different TCI states. The time grid for the first TRP 906a may be associated with the downlink reference timing configured for the first TRP 906a. The time grid for the second TRP 906b may be associated with the downlink reference timing configured for the second TRP 906b. The downlink reference timing for the first TRP 906a may be different from that of the second TRP 906b.

As shown in FIG. 9, based on the absolute time grid associated with GNSS timing, the UE 904 may transmit the first signal 902a and the second signal 902b at different time epochs after applying the timing advance values τ_{A} and τ_{B}, respectively. However, as shown in the logical time grid, from the perspective of the network, the first signal 902a and the second signal 902b are received via the same system frame number index, slot number index and symbol index. That is, from the perspective of the network, the first signal 902a and the second signal 902b appear to be transmitted synchronously, even though they were transmitted at different times via a single Tx antenna.

As further shown in FIG. 9, the network (e.g., the network node 702) may ensure that the UL grant for the second signal 902b occurs before the UL grant for the first signal 902a (i.e., so that the second signal 902b is transmitted before the first signal 902a, as the distance between the UE 904 and the TRP 906b is greater than the distance between the UE 904 and the TRP 906a). As also shown in FIG. 9, the time between transmitting first signal 902a and the second signal 902b is sufficient for the UE 904 to switch the Tx beam from the first TRP 906a to the second TRP 906b and perform RF tuning (i.e., M in_{A,B}(|τ_{B}-τ_{A}|)≥T_{G}).

In an aspect of the present disclosure, a UE may support asynchronous uplink transmissions to multiple TRPs associated with different TAGs on different BWPs and CCs. For example, FIG. 10 is a diagram 1000 illustrating asynchronous uplink transmissions to multiple TRPs associated with different TAGs on different BWPs and CCs utilizing a single Tx antenna in accordance with various aspects of the present disclosure. As shown in FIG. 10, a UE 1004 is configured to transmit uplink signals utilizing a single Tx antenna in accordance with timing advance values received by a network node (e.g., via the configuration received at 716). In particular, the UE 1004 may receive a first timing advance value (τ_{A}) associated with a first TRP 1006a and a second timing advance value (τ_{B}) associated with a second TRP 1006b. The UE 1004 transmits a first signal 1002a to the TRP 1006a and a second signal 1002b to the TRP 1006b utilizing the same Tx antenna based on the timing advance values. The first signal 1002a may bean uplink signal (e.g., a PUSCH, a PUCCH, an SRS, a PRACH, etc.) with a transmission configuration indicator (TCI) state (S_{A}) and a timing advance value (τ_{A}) associated with the first TRP 1006a. The second signal 1002b may be an uplink signal with a TCI state (S_{B}) and a timing advance value (τ_{B}) associated with the second TRP 1006b.

The UE 1004 may be scheduled by DCI or configured by RRC signaling or MAC-CE signaling to transmit the first signal 1002a to the first TRP 1006a and the second signal 1002b to the second TRP 1006b on different uplink BWPs and/or CCs. For example, if the minimum transmit timing different (minTTD) supported by the scheduler (or the minimum timing difference between τ_{A} and τ_{B} associated with different TAGs) are less than the minimum transmit switching gap (T_{G}) and the amount of time (T_{BWP/CC}) it takes the UE 1004 to perform BWP switching and/or CC (or carrier frequency) switching, or the UE 1004 is configured with different uplink BWPS and/or CCs to transmit the first signal 1002a and the second signal 1002b, a dynamic or semi-static time offset (S_{d}) (e.g., for accommodating the amount of time for the UE 1004 to perform at least one of BWP switching or carrier frequency switching) may be configured for the UE 1004 and indicated by sDCI, mDCI, MAC-CE, or RRC). The network may provide the time offset (S_{d}) and the timing advance values τ_{B} and τ_{A} via the configuration provided at 716 to accommodate BWP, CC, and/or Tx beam switching so that the minimum transmit timing difference between two TAGs plus the offset (S_{d}) are no less than the minimum transmit switching gap (T_{G}) and the amount of time (T_{BWP/CC}) it takes the UE 1004 to perform BWP switching and/or CC switching.

As shown in FIG. 10, based on the absolute time grid associated with GNSS timing, the UE 1004 may transmit the first signal 1002a and the second signal 1002b at different times after applying the time offset (S_{d}) and the timing advance values τ_{A} and τ_{B}, respectively. As shown in the logical time grid, the first signal 1002a and the second signal 1002b are received via different system frame number indexes, slot number indexes and symbol indexes and received in accordance with the time offset (S_{d}). As further shown in FIG. 10, the time between transmitting first signal 1002a and the second signal 1002b is sufficient for the UE 1004 to switch the Tx beam from the first TRP 906a to the second TRP 906b, perform RF tuning, and switch the BWPs and/or CCs (i.e., M in_{A,B}(|τ_{B}-τ_{A}|)+S_{d}≥T_{G}+T_{BWP/CC}).

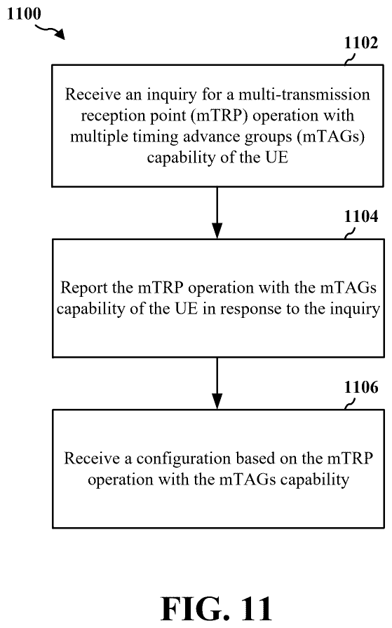

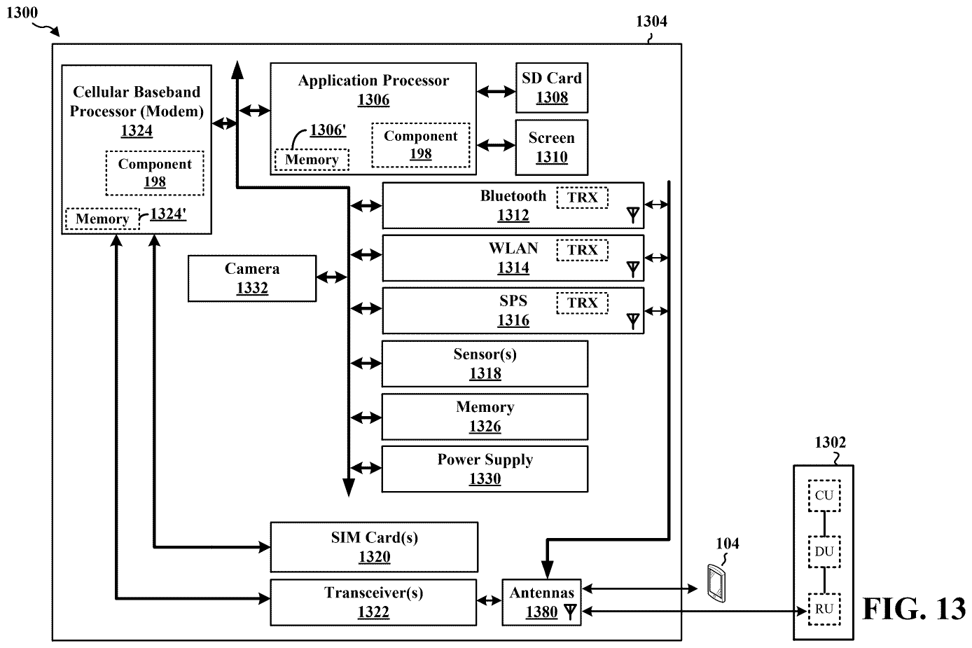

FIG. 11 is a flowchart 1100 illustrating methods of wireless communication at a UE in accordance with various aspects of the present disclosure. The method may be performed by a UE. The UE may be the UE 104, 350, 504, 604, 704, 804, 904, 1004, or the apparatus 1304 in the hardware implementation of FIG. 13.

At 1102, the UE may receive an inquiry for an mTRP operation with mTAGs capability of the UE. For example, referring to FIG. 7, at 712, the UE 704 may receive an inquiry from the network node 702 for an mTRP operation with mTAGs capability of the UE 704. In some aspects, 1102 may be performed by the mTRP operation with mTAGs transmission component 198.

In an aspect, the UE is one of a RedCap UE or a RedComp UE. For example, referring to FIG. 7, the UE 704 may be one of a RedCap UE or a RedComp UE.

In an aspect, the mTRP operation with the mTAGs capability may be for a RedCap UE or a RedComp UE that supports a first number of transmission antenna branches that is less than a second number of multiple TRPs in the mTRP operation. For example, referring to FIG. 7, the mTRP operation with the mTAGs capability inquired about at 712 may be for a RedCap UE or a RedComp UE (e.g., the UE 704) that supports a first number of transmission antenna branches that is less than a second number of multiple TRPs (e.g., the TRPs 706a and 706b) in the mTRP operation.

In an aspect, the UE may receive at least one of transmit timing difference values for an mTRP operation, downlink timing difference values associated with different mTAGs, or a respective downlink timing reference signal for each TAG of the mTAGs. For example, referring to FIG. 7, the UE 704 may, at 708, receive at least one of transmit timing difference values for an mTRP operation, downlink timing difference values associated with different mTAGs, or a respective downlink timing reference signal for each TAG of the mTAGs.

At 1104, the UE may report the mTRP operation with the mTAGs capability of the UE in response to the inquiry. For example, referring to FIG. 7, at 714, the UE 704 may report the mTRP operation with the mTAGs capability to the network node 702. In some aspects, 1104 may be performed by the mTRP operation with mTAGs transmission component 198.

In as aspect, the mTRP operation with the mTAGs capability may be associated with a minimum transmit switching gap supported by the UE. For example, referring to FIG. 7, the mTRP operation with the mTAGs capability reported at 714 may be associated with a minimum transmit switching gap supported by the UE 704.

At 1106, the UE may receive a configuration based on the mTRP operation with the mTAGs capability. For example, referring to FIG. 7, at 716, the UE 704 may receive a configuration based on the mTRP operation with the mTAGs capability from the network node 702. In some aspects, 1106 may be performed by the mTRP operation with mTAGs transmission component 198.

In an aspect, the UE may transmit communication to a first TRP and a second TRP based on the configuration. For example, referring to FIG. 7, the UE 704, at 720, may transmit communication to the first TRP 706a and the second TRP 706b based on the configuration applied at 718.

In an aspect, the configuration is comprised (e.g., included) in one of DCI, RRC signaling, or MAC-CE signaling. For example, referring to FIG. 8, the configuration received at 716 may be received via one of DCI, RRC signaling, or MAC-CE signaling.

In an aspect, the DCI may be one of sDCI or mDCI. For example, referring to FIG. 7, the configuration received at 716 may be received via one of sDCI or mDCI.

In an aspect, the configuration, when applied by the UE, may configure the UE with a first uplink BWP for a first TRP and a second uplink BWP for a second TRP. For example, referring to FIG. 7, the configuration applied at 718 may configure the UE 704 with a first uplink BWP for the first TRP 706a and a second uplink BWP for the second TRP 706b. In another example, referring to FIG. 8, the configuration applied at 718 may configure the UE 804 with a first uplink BWP for the first TRP 806a and a second uplink BWP for the second TRP 806b.

In an aspect, the first uplink BWP may be associated with a first TAG and the second uplink BWP may be associated with a second TAG. For example, referring to FIG. 7, the configuration applied at 718 may configure the UE 704 such that the first uplink BWP is associated with a first TAG (e.g., associated with the first TRP 706a) and the second uplink BWP is associated with a second TAG (e.g., associated with the second TRP 706b). In another example, referring to FIG. 8, the configuration applied at 718 may configure the UE 804 such that the first uplink BWP is associated with a first TAG (e.g., associated with the first TRP 806a) and the second uplink BWP is associated with a second TAG (e.g., associated with the second TRP 806b).

In an aspect, an absolute minimum transmit timing difference supported by the first TRP and the second TRP may be no less than the minimum transmit switching gap. For example, referring to FIG. 7, an absolute minimum transmit timing difference supported by the first TRP 706a and the second TRP 706b may be no less than the minimum transmit switching gap reported by the UE 704 at 714. In another example, referring to FIG. 8, an absolute minimum transmit timing difference supported by the first TRP 806a and the second TRP 806b may be no less than the minimum transmit switching gap (T_{G}).

In an aspect, the configuration, when applied by the UE, may configure the UE to transmit a first uplink signal to a first TRP and a second uplink signal to a second TRP via a same uplink BWP and at least one of a same frame index, slot index, or symbol index. For example, referring to FIG. 7, the configuration applied at 718 may configure the UE 704 to transmit a first uplink signal to the first TRP 706a and a second uplink signal to the second TRP 706b via a same uplink BWP and at least one of a same frame index, slot index, or symbol index. In another example, referring to FIG. 9, the configuration applied at 718 may configure the UE 904 to transmit the first signal 902a to the first TRP 906a and the second signal 902b to the second TRP 906b via a same uplink BWP and at least one of a same frame index, slot index, or symbol index.

In an aspect, the first uplink signal is associated with a first TAG and a first TCI state and the second uplink signal is associated with a second timing advance group and a second TCI state. For example, referring to FIG. 9, the first signal 902a is associated with a first TAG and a first TCI state and the second signal 902b is associated with a second TAG and a second TCI state.

In an aspect, the configuration, when applied by the UE, may configure the UE to transmit a first uplink signal to a first TRP via a first BWP and a first carrier frequency and to transmit a second uplink signal to a second TRP via a second BWP and a second carrier frequency. For example, referring to FIG. 7, the configuration applied at 718 may configure the UE 704 to transmit a first uplink signal to the first TRP 706a via a first BWP and a first carrier frequency and to transmit a second uplink signal to the second TRP 706b via a second BWP and a second carrier frequency. In another example, referring to FIG. 10, the configuration applied at 718 may configure the UE 1004 to transmit the first signal 1002a to the first TRP 1006a via a first BWP and a first carrier frequency and the second signal 1002b to the second TRP 1006b via a via a second BWP and a second carrier frequency.

In an aspect, a combination of an absolute minimum transmit timing difference supported by the first TRP and the second TRP and the time offset is no less than a combination of the minimum transmit switching gap and the amount of time for the UE to perform at least one of the BWP switching or the carrier frequency switching. For example, referring to FIG. 7, an absolute minimum transmit timing difference supported by the first TRP 706a and the second TRP 706b may be no less than a combination (e.g., a sum) of the minimum transmit switching gap and the amount of time for the UE 704 to perform at least one of the BWP switching or the carrier frequency switching reported by the UE 704 at 714. In another example, referring to FIG. 10, an absolute minimum transmit timing difference supported by the first TRP 1006a and the second TRP 1006b may be no less than a combination (e.g., a sum) of the minimum transmit switching gap and the amount of time for the UE 704 to perform at least one of the BWP switching or the carrier frequency switching (e.g., T_{BWP/CC}+T_{G}).

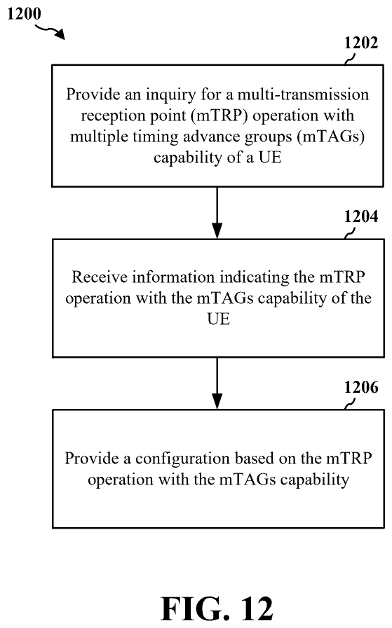

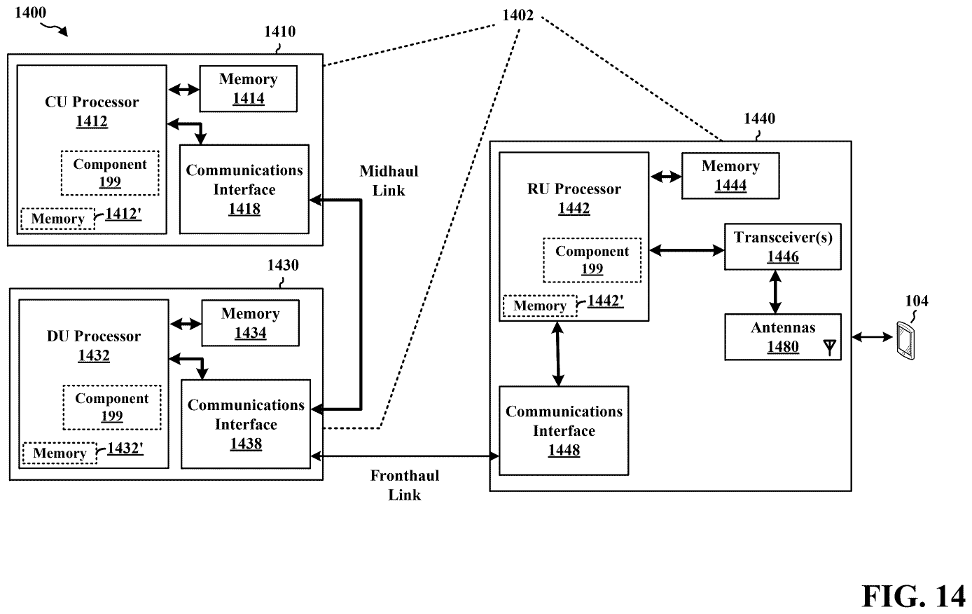

FIG. 12 is a flowchart 1200 illustrating methods of wireless communication at a network node in accordance with various aspects of the present disclosure. The method may be performed by a network node. The network node may be a base station, or a component of a base station, in the access network of FIG. 1 or a core network component (e.g., base station 102, 310; the CU 110, the DU 130; the RU 140; the network node 702, the TRPs 706a and/or 706b, the TRPs 806a and/or 806b, the TRPs 906a and/or 906b, or the TRPs 1006a and/or 1006b; or the network entity 1402 in the hardware implementation of FIG. 14).

At 1202, the network node may provide an inquiry for an mTRP operation with mTAGs capability of a UE. For example, referring to FIG. 7, at 712, the network node 702 may provide an inquiry to the UE 704 for an mTRP operation with mTAGs capability of the UE 704. In some aspects, 1202 may be performed by the mTRP operation with mTAGs configuration component 199.

In an aspect, the mTRP operation with the mTAGs capability may be for a RedCap UE or a RedComp UE that supports a first number of transmission antenna branches that is less than a second number of multiple TRPs in the mTRP operation. For example, referring to FIG. 7, the mTRP operation with the mTAGs capability inquired about at 712 may be for a RedCap UE or a RedComp UE (e.g., the UE 704) that supports a first number of transmission antenna branches that is less than a second number of multiple TRPs (e.g., the TRPs 706a and 706b) in the mTRP operation.

In an aspect, the network node may provide at least one of transmit timing difference values for an mTRP operation, downlink timing difference values associated with different mTAGs, or a respective downlink timing reference signal for each TAG of the mTAGs. For example, referring to FIG. 7, the network node 702 may, at 708, provide at least one of transmit timing difference values for an mTRP operation, downlink timing difference values associated with different mTAGs, or a respective downlink timing reference signal for each TAG of the mTAGs.

At 1204, the network node may receive information indicating the mTRP operation with the mTAGs capability of the UE from the UE in response to the inquiry. For example, referring to FIG. 7, at 714, the network node 702 may receive information (e.g., a report) indicating the mTRP operation with the mTAGs capability of the UE 704 form the UE 704. In some aspects, 1104 may be performed by the mTRP operation with mTAGs configuration component 199.

In as aspect, the mTRP operation with mTAGs capability may be associated with a minimum transmit switching gap supported by the UE. For example, referring to FIG. 7, the mTRP operation with the mTAGs capability information received at 714 by the network node 702 may be associated with a minimum transmit switching gap supported by the UE 704.

At 1206, the network node may provide a configuration based on the mTRP operation with the mTAGs capability. For example, referring to FIG. 7, at 716, the network node 702 may provide a configuration based on the mTRP operation with the mTAGs capability to the UE 704. In some aspects, 1106 may be performed by the mTRP operation with mTAGs configuration component 199.

In an aspect, the network node may receive communication based on the configuration. For example, referring to FIG. 7, at 720, the first TRP 706a and/or the second TRP 706b associated with the network node 702 may receive communication from the UE 704 based on the configuration provided at 716.

In an aspect, the configuration is included in one of DCI, RRC signaling, or MAC-CE signaling. For example, referring to FIG. 8, the configuration provided at 716 may be provided via one of DCI, RRC signaling, or MAC-CE signaling.

In an aspect, the DCI may be one of sDCI or mDCI. For example, referring to FIG. 7, the configuration provided at 716 may be provided via one of sDCI or mDCI.

In an aspect, the configuration is to configure the UE with a first uplink BWP for a first TRP and a second uplink BWP for a second TRP. For example, referring to FIG. 7, the configuration provided at 716 may configure the UE 704 with a first uplink BWP for the first TRP 706a and a second uplink BWP for the second TRP 706b. In another example, referring to FIG. 8, the configuration provided at 716 may configure the UE 804 with a first uplink BWP for the first TRP 806a and a second uplink BWP for the second TRP 806b.

In an aspect, the first uplink BWP may be associated with a first TAG and the second uplink BWP may be associated with a second TAG. For example, referring to FIG. 7, the configuration provided at 716 may configure the UE 704 such that the first uplink BWP is associated with a first TAG (e.g., associated with the first TRP 706a) and the second uplink BWP is associated with a second TAG (e.g., associated with the second TRP 706b). In another example, referring to FIG. 8, the configuration provided at 716 may configure the UE 804 such that the first uplink BWP is associated with a first TAG (e.g., associated with the first TRP 806a) and the second uplink BWP is associated with a second TAG (e.g., associated with the second TRP 806b).

In an aspect, an absolute minimum transmit timing difference supported by the first TRP and the second TRP may be no less than the minimum transmit switching gap. For example, referring to FIG. 7, an absolute minimum transmit timing difference supported by the first TRP 706a and the second TRP 706b may be no less than the minimum transmit switching gap reported by the UE 704 at 714. In another example, referring to FIG. 8, an absolute minimum transmit timing difference supported by the first TRP 806a and the second TRP 806b may be no less than the minimum transmit switching gap (T_{G}).

In an aspect, the configuration is to configure the UE to transmit a first uplink signal to a first TRP and a second uplink signal to a second TRP via a same uplink BWP and at least one of a same frame index, slot index, or symbol index. For example, referring to FIG. 7, the configuration provided at 716 may configure the UE 704 to transmit a first uplink signal to the first TRP 706a and a second uplink signal to the second TRP 706b via a same uplink BWP and at least one of a same frame index, slot index, or symbol index. In another example, referring to FIG. 9, the configuration provided at 716 may configure the UE 904 to transmit the first signal 902a to the first TRP 906a and the second signal 902b to the second TRP 906b via a same uplink BWP and at least one of a same frame index, slot index, or symbol index.

In an aspect, the first uplink signal is associated with a first TAG and a first TCI state and the second uplink signal is associated with a second timing advance group and a second TCI state. For example, referring to FIG. 9, the first signal 902a is associated with a first TAG and a first TCI state and the second signal 902b is associated with a second TAG and a second TCI state.

In an aspect, the configuration is to configure the UE to transmit a first uplink signal to a first TRP via a first BWP and a first carrier frequency and to transmit a second uplink signal to a second TRP via a second BWP and a second carrier frequency. For example, referring to FIG. 7, the configuration provided at 716 may configure the UE 704 to transmit a first uplink signal to the first TRP 706a via a first BWP and a first carrier frequency and to transmit a second uplink signal to the second TRP 706b via a second BWP and a second carrier frequency. In another example, referring to FIG. 10, the configuration provided at 716 may configure the UE 1004 to transmit the first signal 1002a to the first TRP 1006a via a first BWP and a first carrier frequency and the second signal 1002b to the second TRP 1006b via a via a second BWP and a second carrier frequency.

In an aspect, a combination of an absolute minimum transmit timing difference supported by the first TRP and the second TRP and the time offset is no less than a combination of the minimum transmit switching gap and the amount of time for the UE to perform at least one of the BWP switching or the carrier frequency switching. For example, referring to FIG. 7, an absolute minimum transmit timing difference supported by the first TRP 706a and the second TRP 706b may be no less than a combination (e.g., a sum) of the minimum transmit switching gap and the amount of time for the UE 704 to perform at least one of the BWP switching or the carrier frequency switching reported by the UE 704 at 714. In another example, referring to FIG. 10, an absolute minimum transmit timing difference supported by the first TRP 1006a and the second TRP 1006b may be no less than a combination (e.g., a sum) of the minimum transmit switching gap and the amount of time for the UE 704 to perform at least one of the BWP switching or the carrier frequency switching (e.g., T_{BWP/CC}+T_{G}).

FIG. 13 is a diagram 1300 illustrating an example of a hardware implementation for an apparatus 1304. The apparatus 1304 may be a UE, a component of a UE, or may implement UE functionality. In some aspects, the apparatus 1304 may include a cellular baseband processor 1324 (also referred to as a modem) coupled to one or more transceivers 1322 (e.g., cellular RF transceiver). The cellular baseband processor 1324 may include on-chip memory 1324′. In some aspects, the apparatus 1304 may further include one or more subscriber identity modules (SIM) cards 1320 and an application processor 1306 coupled to a secure digital (SD) card 1308 and a screen 1310. The application processor 1306 may include on-chip memory 1306′. In some aspects, the apparatus 1304 may further include a Bluetooth module 1312, a WLAN module 1314, an SPS module 1316 (e.g., GNSS module), one or more sensor modules 1318 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1326, a power supply 1330, and/or a camera 1332. The Bluetooth module 1312, the WLAN module 1314, and the SPS module 1316 may include an on-chip transceiver (TRX) (or in some cases, just a receiver (RX)). The Bluetooth module 1312, the WLAN module 1314, and the SPS module 1316 may include their own dedicated antennas and/or utilize the antennas 1380 for communication. The cellular baseband processor 1324 communicates through the transceiver(s) 1322 via one or more antennas 1380 with the UE 104 and/or with an RU associated with a network entity 1302. The cellular baseband processor 1324 and the application processor 1306 may each include a computer-readable medium/memory 1324′, 1306′, respectively. The additional memory modules 1326 may also be considered a computer-readable medium/memory. Each computer-readable medium/memory 1324′, 1306′, 1326 may be non-transitory. The cellular baseband processor 1324 and the application processor 1306 are each responsible for general processing, including the execution of software stored on the computer-readable medium/memory. The software, when executed by the cellular baseband processor 1324/application processor 1306, causes the cellular baseband processor 1324/application processor 1306 to perform the various functions described spa. The computer-readable medium/memory may also be used for storing data that is manipulated by the cellular baseband processor 1324/application processor 1306 when executing software. The cellular baseband processor 1324/application processor 1306 may be a component of the UE 350 and may include the memory 360 and/or at least one of the TX processor 368, the RX processor 356, and the controller/processor 359. In one configuration, the apparatus 1304 may be a processor chip (modem and/or application) and include just the cellular baseband processor 1324 and/or the application processor 1306, and in another configuration, the apparatus 1304 may be the entire UE (e.g., see UE 350 of FIG. 3) and include the additional modules of the apparatus 1304.

As discussed spa, the component 198 may be configured to receive an inquiry for an mTRP operation with mTAGs capability of the UE, report the mTRP operation with the mTAGs capability of the UE in response to the inquiry, and receive a configuration based on the mTRP operation with the mTAGs capability. The component 198 may be further configured to perform any of the aspects described in connection with the flowchart in FIG. 11 and/or the aspects performed by the UE in the communication flow in FIG. 7. The component 198 may be within the cellular baseband processor 1324, the application processor 1306, or both the cellular baseband processor 1324 and the application processor 1306. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1304 may include a variety of components configured for various functions. In one configuration, the apparatus 1304, and in particular the cellular baseband processor 1324 and/or the application processor 1306, may include means for receiving an inquiry for an mTRP operation with mTAGs capability of the UE, means for reporting the mTRP operation with the mTAGs capability of the UE in response to the inquiry, and means for receiving a configuration based on the mTRP operation with the mTAGs capability. The means may be the component 198 of the apparatus 1304 configured to perform the functions recited by the means. As described supra, the apparatus 1304 may include the TX processor 368, the RX processor 356, and the controller/processor 359. As such, in one configuration, the means may be the TX processor 368, the RX processor 356, and/or the controller/processor 359 configured to perform the functions recited by the means.

FIG. 14 is a diagram 1400 illustrating an example of a hardware implementation for a network entity 1402. The network entity 1402 may be a BS, a component of a BS, or may implement BS functionality. The network entity 1402 may include at least one of a CU 1410, a DU 1430, or an RU 1440. For example, depending on the layer functionality handled by the component 199, the network entity 1402 may include the CU 1410; both the CU 1410 and the DU 1430; each of the CU 1410, the DU 1430, and the RU 1440; the DU 1430; both the DU 1430 and the RU 1440; or the RU 1440. The CU 1410 may include a CU processor 1412. The CU processor 1412 may include on-chip memory 1412′. In some aspects, the CU 1410 may further include additional memory modules 1414 and a communications interface 1418. The CU 1410 communicates with the DU 1430 through a midhaul link, such as an F1 interface. The DU 1430 may include a DU processor 1432. The DU processor 1432 may include on-chip memory 1432′. In some aspects, the DU 1430 may further include additional memory modules 1434 and a communications interface 1438. The DU 1430 communicates with the RU 1440 through a fronthaul link. The RU 1440 may include an RU processor 1442. The RU processor 1442 may include on-chip memory 1442′. In some aspects, the RU 1440 may further include additional memory modules 1444, one or more transceivers 1446, antennas 1480, and a communications interface 1448. The RU 1440 communicates with the UE 104. The on-chip memory 1412′, 1432′, 1442′ and the additional memory modules 1414, 1434, 1444 may each be considered a computer-readable medium/memory. Each computer-readable medium/memory may be non-transitory. Each of the processors 1412, 1432, 1442 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed spa, the component 199 may be configured to provide an inquiry for an mTRP operation with mTAGs capability of a UE, receive information indicating the mTRP operation with the mTAGs capability of the UE, and provide a configuration based on the mTRP operation with the mTAGs capability. The component 199 may be further configured to perform any of the aspects described in connection with the flowchart in FIG. 12 and/or the aspects performed by the UE in the communication flow in FIG. 7. The component 199 may be within one or more processors of one or more of the CU 1410, DU 1430, and the RU 1440. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1402 may include a variety of components configured for various functions. In one configuration, the network entity 1402 may include means for providing an inquiry for an mTRP operation with mTAGs capability of a UE, means for receiving information indicating the mTRP operation with the mTAGs capability of the UE, and means for providing a configuration based on the mTRP operation with the mTAGs capability. The means may be the component 199 of the network entity 1402 configured to perform the functions recited by the means. As described spa, the network entity 1402 may include the TX processor 316, the RX processor 370, and the controller/processor 375. As such, in one configuration, the means may be the TX processor 316, the RX processor 370, and/or the controller/processor 375 configured to perform the functions recited by the means.

Various aspects relate generally to wireless communication and more particularly to multi-transmission reception point (mTRP) operations with mTAGs. Some aspects more specifically relate to enabling a RedCap UE or RedComp UE (e.g., a UE utilizing a single transmit antenna) to transmit signals to different TRPs with mTAGs at different time instances utilizing transmit beam switching, bandwidth switching and/or carrier frequency switching. In some aspects, the network may configure the UE such that that uplink signal transmission to different TRPs with mTAGs takes into account the absolute minimum transmit timing supported by the multiple TRPs and the time it takes for the UE to switch transmit beams to different TRPs. In one example, the signals may be transmitted by the UE via the same uplink bandwidth part (BWP) and the same frame index, slot index, and symbol index. As such, the network may perceive the signals to be transmitted synchronously even though the UE transmits the signals at different time instances. In another example, the UE may transmit signals asynchronously to different TRPs with mTAGs via different BWPs and carrier frequencies. In this example, the network may configure the UE such that uplink signal transmission to different TRPs with mTAGs takes into account the absolute minimum transmit timing supported by the multiple TRPs and the time it takes for the UE to switch transmit beams to a different TRP, switch BWPs, and switch carrier frequencies.

Particular aspects of the subject matter described in this disclosure can be implemented to realize one or more of the following potential advantages. In some examples, by configuring a RedCap UE or RedComp UE to take into account the absolute minimum transmit timing supported by multiple TRPs as well as the time it takes the UE to switch beams, BWPs, and/or carrier frequencies, the described techniques enable a RedCap UE or RedComp UE to transmit signals to different TRPs with mTAGs utilizing a single transmit antenna. Supporting mTRP operations with mTAGs for a RedCap UE or a RedComp UE may be advantageous to both the UE and the network. For instance, such aspects may achieve load balancing for uplink traffic across multiple TRPs, time and space diversity for uplink data and control, and improved coverage, reliability, and/or capacity.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a UE, including receiving an inquiry for an mTRP operation with mTAGs capability of the UE; reporting the mTRP operation with the mTAGs capability of the UE in response to the inquiry; and receiving a configuration based on the mTRP operation with the mTAGs capability.

Aspect 2 is the method of aspect 1, where the mTRP operation with the mTAGs capability is for a RedCap UE or a RedComp UE that supports a first number of transmission antenna branches that is less than a second number of multiple TRPs in the mTRP operation.

Aspect 3 is the method of any of aspects 1 and 2, further including receiving at least one of: transmit timing difference values for an mTRP operation; downlink timing difference values associated with different mTAGs; or a respective downlink timing reference signal for each TAG of the mTAGs.

Aspect 4 is the method of any of aspects 1 to 3, where the mTRP operation with the mTAGs capability is associated with a minimum transmit switching gap supported by the UE.

Aspect 5 is the method of any of aspects 1 to 4, further including transmitting communication to a first TRP and a second TRP based on the configuration.

Aspect 6 is the method of any of aspects 1 to 5, where the configuration, when applied by the UE, configures the UE with a first uplink bandwidth part for a first TRP and a second uplink bandwidth part for a second TRP.

Aspect 7 is the method of aspect 6, where the first uplink bandwidth part is associated with a first timing advance group and the second uplink bandwidth part is associated with a second timing advance group.

Aspect 8 is the method of any of aspects 1 to 7, where an absolute minimum transmit timing difference supported by the first TRP and the second TRP is no less than the minimum transmit switching gap.

Aspect 9 is the method of any of aspects 1 to 8, where the configuration is included in one of DCI, RRC signaling, or MAC-CE signaling.

Aspect 10 is the method of aspect 8, where the DCI is one of sDCI or mDCI.

Aspect 11 is the method of any of aspects 1 to 5, 9, or 10, where the configuration, when applied by the UE, configures the UE to transmit a first uplink signal to a first TRP and a second uplink signal to a second TRP via a same uplink bandwidth part and at least one of a same frame index, slot index, or symbol index.

Aspect 12 is the method of aspect 11, where the first uplink signal is associated with a first timing advance group and a first TCI state and the second uplink signal is associated with a second timing advance group and a second TCI state.

Aspect 13 is the method of any of aspects 1 to 5, 9, or 10, where the configuration, when applied by the UE, configures the UE to transmit a first uplink signal to a first TRP via a first bandwidth part and a first carrier frequency and to transmit a second uplink signal to a second TRP via a second bandwidth part and a second carrier frequency.

Aspect 14 is the method of aspect 13, where the configuration further configures the UE with a time offset for accommodating an amount of time for the UE to perform at least one of BWP switching or carrier frequency switching.

Aspect 15 is the method of aspect 14, where a combination of an absolute minimum transmit timing difference supported by the first TRP and the second TRP and the time offset is no less than a combination of the minimum transmit switching gap and the amount of time for the UE to perform at least one of the BWP switching or the carrier frequency switching.

Aspect 16 is the method of any of aspects 1 to 15, where the UE is one of a RedCap UE or a RedComp UE.

Aspect 17 is a method of wireless communication at a network node, including providing an inquiry for an mTRP operation with mTAGs capability of the UE; receiving information indicating the mTRP operation with the mTAGs capability of the UE in response to the inquiry; and providing a configuration based on the mTRP operation with the mTAGs capability.

Aspect 18 is the method of aspect 17, where the mTRP operation with the mTAGs capability is for a RedCap UE or a RedComp UE that supports a first number of transmission antenna branches that is less than a second number of multiple TRPs in the mTRP operation.

Aspect 19 is the method of any of aspects 17 and 18, further including providing at least one of: transmit timing difference values for an mTRP operation; downlink timing difference values associated with different mTAGs; or a respective downlink timing reference signal for each TAG of the mTAGs.

Aspect 20 is the method of any of aspects 17 to 19, where the mTRP operation with the mTAGs capability is associated with a minimum transmit switching gap supported by the UE.

Aspect 21 is the method of any of aspects 17 to 20, further including receiving communication based on the configuration.

Aspect 22 is the method of any of aspects 17 to 21, where the configuration is to configure the UE with a first uplink bandwidth part for a first TRP and a second uplink bandwidth part for a second TRP.

Aspect 23 is the method of aspect 22, where the first uplink bandwidth part is associated with a first timing advance group and the second uplink bandwidth partis associated with a second timing advance group.

Aspect 24 is the method of any of aspects 17 to 23, where an absolute minimum transmit timing difference supported by the first TRP and the second TRP is no less than the minimum transmit switching gap.

Aspect 25 is the method of any of aspects 17 to 24, where the configuration is included in one of DCI, RRC signaling, or MAC-CE signaling.

Aspect 26 is the method of aspect 25, where the DC is one of sDCI or mDCI.

Aspect 27 is the method of any of aspects 17 to 21, 25 or 26, where the configuration is to configure the UE to transmit a first uplink signal to a first TRP and a second uplink signal to a second TRP via a same uplink bandwidth part and at least one of a same frame index, slot index, or symbol index.

Aspect 28 is the method of aspect 27, where the first uplink signal is associated with a first timing advance group and a first TCI state and the second uplink signal is associated with a second timing advance group and a second TCI state.

Aspect 29 is an apparatus for wireless communication at a UE. The apparatus includes memory; and at least one processor coupled to the memory and, based at least in part on information stored in the memory, the at least one processor is configured to implement any of aspects 1 to 16.

Aspect 30 is the apparatus of aspect 29, further including at least one of a transceiver or an antenna coupled to the at least one processor.

Aspect 31 is an apparatus for wireless communication at a UE. The apparatus includes memory; and at least one processor coupled to the memory and, based at least in part on information stored in the memory, the at least one processor is configured to implement any of aspects 17 to 28.

Aspect 32 is the apparatus of aspect 31, further including at least one of a transceiver or an antenna coupled to the at least one processor.

Aspect 33 is an apparatus for wireless communication including means for implementing any of aspects 1 to 16.

Aspect 34 is an apparatus for wireless communication including means for implementing any of aspects 17 to 28.

Aspect 35 is a computer-readable medium (e.g., a non-transitory computer-readable medium) storing computer executable code, the code when executed by at least one processor causes the at least one processor to implement any of aspects 1 to 16.

Aspect 36 is a computer-readable medium (e.g., a non-transitory computer-readable medium) storing computer executable code, the code when executed by at least one processor causes the at least one processor to implement any of aspects 17 to 28.

1. An apparatus of wireless communication at a first user equipment (UE), comprising:
memory; and
at least one processor coupled to the memory and, based at least in part on information stored in the memory, the at least one processor is configured to:
receive an inquiry for a multi-transmission reception point (mTRP) operation with multiple timing advance groups (mTAGs) capability of the UE;
report the mTRP operation with the mTAGs capability of the UE in response to the inquiry; and
receive a configuration based on the mTRP operation with the mTAGs capability.

2. The apparatus of claim 1, wherein the mTRP operation with the mTAGs capability is for a reduced capability (RedCap) UE or a reduced complexity (RedComp) UE that supports a first number of transmission antenna branches that is less than a second number of multiple transmission reception points (TRPs) in the mTRP operation.

3. The apparatus of claim 1, wherein the at least one processor is further configured to receive at least one of:
transmit timing difference values for an mTRP operation;
downlink timing difference values associated with different mTAGs; or
a respective downlink timing reference signal for each TAG of the mTAGs.

4. The apparatus of claim 1, wherein the mTRP operation with the mTAGs capability is associated with a minimum transmit switching gap supported by the UE.

5. The apparatus of claim 1, wherein the at least one processor is further configured to:
transmit communication to a first TRP and a second TRP based on the configuration.

6. The apparatus of claim 4, wherein the configuration, when applied by the UE, configures the UE with a first uplink bandwidth part for a first TRP and a second uplink bandwidth part for a second TRP.

7. The apparatus of claim 6, wherein the first uplink bandwidth part is associated with a first timing advance group and the second uplink bandwidth part is associated with a second timing advance group.

8. The apparatus of claim 6, wherein an absolute minimum transmit timing difference supported by the first TRP and the second TRP is no less than the minimum transmit switching gap.

9. The apparatus of claim 1, wherein the configuration is comprised in one of downlink control information (DCI), radio resource control (RRC) signaling, or medium access control control element (MAC-CE) signaling.

10. The apparatus of claim 9, wherein the DCI is one of single DCI (sDCI) or multi-DCI (mDCI).

11. The apparatus of claim 4, wherein the configuration, when applied by the UE, configures the UE to transmit a first uplink signal to a first TRP and a second uplink signal to a second TRP via a same uplink bandwidth part and at least one of a same frame index, slot index, or symbol index.

12. (canceled)

13. The apparatus of claim 4, wherein the configuration, when applied by the UE, configures the UE to transmit a first uplink signal to a first TRP via a first bandwidth part and a first carrier frequency and to transmit a second uplink signal to a second TRP via a second bandwidth part and a second carrier frequency.

14-15. (canceled)

16. The apparatus of claim 1, wherein the UE is one of a RedCap UE or a RedComp UE.

17. An apparatus of wireless communication at a network node, comprising: memory; and
at least one processor coupled to the memory and, based at least in part on stored information in the memory, the at least one processor is configured to:
provide an inquiry for a multi-transmission reception point (mTRP) operation with multiple timing advance groups (mTAGs) capability of a UE;
receive information indicating the mTRP operation with the mTAGs capability of the UE; and
provide a configuration based on the mTRP operation with the mTAGs capability.

18. The apparatus of claim 17, wherein the mTRP operation with the mTAGs capability is for a reduced capability (RedCap) UE or a reduced complexity (RedComp) UE that supports a first number of transmission antenna branches that is less than a second number of multiple transmission reception points (TRPs) in the mTRP operation.

19. The apparatus of claim 17, wherein the at least one processor is further configured to provide at least one of:
transmit timing difference values for an mTRP operation;
downlink timing difference values associated with different mTAGs; or
a respective downlink timing reference signal for each TAG of the mTAGs.

20. The apparatus of claim 17, wherein the mTRP operation with the mTAGs capability is associated with a minimum transmit switching gap supported by the UE.

21. The apparatus of claim 17, wherein the at least one processor is further configured to:
receive communication based on the configuration.

22-24. (canceled)

25. The apparatus of claim 17, wherein the configuration is comprised in one of downlink control information (DCI), radio resource control (RRC) signaling, or medium access control control element (MAC-CE) signaling.

26-28. (canceled)

29. A method for wireless communication at a user equipment (UE), comprising:
receiving an inquiry for a multi-transmission reception point (mTRP) operation with multiple timing advance groups (mTAGs) capability of the UE;
reporting the mTRP operation with the mTAGs capability of the UE in response to the inquiry; and
receiving a configuration based on the mTRP operation with the mTAGs capability.

30. (canceled)
